(19) United States
(12) Patent Application Publication
(10) Pub. No.: US 2004/0136359 A1
(43) Pub. Date: Jul. 15, 2004

(54) Communication system architecture to converge voice and data services for point- to-multipoint transmission

(76) Inventors: David Ivancovsky, Maccabim (IL); David Levi, Jerusalem (IL)

Correspondence Address: NATH & ASSOCIATES, 1030 15th STREET, 6TH FLOOR, WASHINGTON, DC, 20005, US

(21) Appl. No.: 10/479,340

(22) PCT Filed: May 22, 2002
(86) PCT No.: PCT/IL02/00404

(30) Foreign Application Priority Data
May 30, 2001 (IL) 143456

(51) Int. Cl. H04L 12/66; H04Q 11/00; H04L 12/50

(52) U.S. Cl. 370/352; 370/385

(57) ABSTRACT

The invention relates to a method for converging data signals over a data network having a data network protocol and voice information.

### FIELD OF THE INVENTION

The present invention generally relates to communication networks. More specifically the present invention relates to communication system architecture to converge voice and data services for point-to-multipoint transmission over a passive optical network (PON).

### BACKGROUND OF THE INVENTION

Traditionally Small-to-Medium Enterprise (SME) businesses had a Private Business exchange (PBX) to serve their internal phone calls and to have access to the Public Switching Telephone Network (PSTN). In the case of small businesses Basic Rate Interface (BRI) or analog two-wire (2-W) is commonly used. For more than a few external lines T1 or E1 is preferably used. The signaling protocols can either be channel associated signaling (CAS) or common channel signaling (CCS). CCS signaling is mostly Primary Rate Interface (PRI).

With the evolving needs for data access, those customers started to purchase equipment to connect their Local Area Network (LAN) to the Wide Area Network (WAN). Such a development brought them to have at least two different technologies with two different service providers.

There are several well-known technologies that are used as the transmission media to bridge between the metro network and the customers, which are known as access technologies. Among these known technologies are Passive Optical Networks (PON), Wireless Local Loop (WLL) and Cable Modem. These technologies have one thing in common—a point to multipoint topology. Such a topology creates a potentially disadvantageous situation where the data flow is non-symmetrical. Data is continuously broadcast in the downstream direction—i.e. from the Line Termination (LT) to the Network Termination (NT), whereas in the upstream direction—a Time Division Multiple Access (TDMA) mechanism is used. Through this mechanism each NT is allocated a time-slot for sending information.

Much activity is presently being directed into the design and deployment of point-to-multipoint broadband access networks, wherein downstream signals are broadcast from a single LT facility to multiple NT end user stations (i.e., via “point-to-multipoint” transmission), and upstream signals are transmitted from each respective NT end user to the LT facility (i.e., via “point-to-point” transmission), respectively. It is presently anticipated that point-to-multipoint broadband access networks will be employed to support a variety of independent communication services, such as, e.g., traditional two-way telecommunications, broadcast video (i.e., CATV) services and a full range of digital baseband services.

The use of relatively low noise, high speed point-to-multipoint optical networks to support the two-way transmission of a wide variety of broadband data services is especially desirable in that optical networks are capable of transporting relatively large amounts of data in short time periods.

Thus, it would be desirable to provide a network architecture that will dynamically and adaptively converge a number of communication nodes sharing a common point-to-multipoint communication network, such as a relatively high speed, low noise, passive optical network, while simultaneously supporting multiple types of traffic.

### SUMMARY OF THE INVENTION

Accordingly, it is a principal object of the present invention to overcome the limitations of existing architecture, and to provide a converged solution of data and voice transmission, which is cost affective to both the customer and the service providers.

It is a further object of present invention to provide a network architecture that supports both downstream and upstream transmission of digital voice and data, point-to-multipoint broadband access network, such as a relatively low noise, high-speed passive optical network (PON).

The present invention relates to a method for converging data signals over a data network having a data network protocol and voice information, including pulse code modulated voice samples and signaling protocols, over a voice network having a voice network protocol using a point network to multipoint network system architecture, wherein said multipoint network has at least two network terminations (NT's). The steps involved are receiving a first telephone call, originated by a PBX, at one of two or more network terminations, receiving a second telephone call, originated by a PBX, at another of the two or more two network terminations, transferring the voice samples from the NT of the first call to the line termination (LT) of the multipoint network, and from the NT of the second call to the LT of the multipoint network, wherein the first call and the second call are still active calls. The next steps are multiplexing the first call in the line termination to connect to the public switched telephone network (PSTN) via a transmission channel and multiplexing the second call in the line termination to connect to the PSTN via a transmission channel, such that the multiplexing results a saving of the number of transmission channels required.

The multiplexing is done via the technology of a digital access and cross-connect system ([)ACS). Also, generally more than two calls are multiplexed, and only active calls are transferred, thereby resulting in savings of bandwidth. Also, there may be implementation of dynamic bandwidth allocation (DBA) algorithms for said data signals.

The present invention comprises a point-to-multipoint converged network, wherein a data network and a voice network are combined using simple and legacy technologies for voice convergence instead of the complicated Vo/IP or Vo/ATM. Each network termination (NT), for both data and voice, is generally located at a different customer's premises. The line termination (LT) aggregates all the upstream traffic, which is in native form from many NT's. The convergence network line is, for example, a fiber optic, passive optical network (PON).

Various technologies are used to provide a converged solution to the customer needs. Those technologies take the voice and convert it into transmission units (ATM cells or IP packets) and then integrate it with the data packets. This conversion is done in real-time, so the voice is compressed to minimize the delay. Also, to overcome delay problems, an echo cancellation technique is used, which simply requires a digital signal processor (DSP) in each NT. On the LT side the voice is de-compressed and derived from the data transmitted towards the PSTN. Voice signaling is also converted to protocols like V5.2 or GR-303 using an access concentrator mechanism combining software and hardware logic.

The solution has several characteristics:

voice is transferred in a native format—i.e., using pulse coded modulation (PCM) samples;

voice signaling is relayed to the PSTN; and

bandwidth for voice and data calls is allocated dynamically.

### DEFINITION OF TERMS USED IN DESCRIBING THE INVENTION

ATM Asynchronous Transfer Mode. A type of protocol for service transfer for fast packet switching that uses a fixed size packet called a cell. This technique makes it possible to transmit data at great speed, and can make voice, multimedia, full-motion video, and video conferencing available to all users. It also makes dynamic allocation of bandwidth possible; telephone and cable TV companies can charge individual customers based on the amount of bandwidth they use. ATM is the standard used by telecommunications company backbones.

BRI Basic Rate Interface. This ISDN service is currently offered by many telephone companies for home users. With only slight modifications to existing telephone service, ISDN BRI allows up to 128-kbps throughput. It consists of two 64-kbps B channels for carrying data or voice and one 16-kbps D channel for call setup and signaling. BRI service is therefore sometimes referred to as 2B+D.

CAS Channel Associated Signaling. A form of circuit state signaling in which the circuit state is indicated by one or more bits of signaling status sent repetitively and associated with that specific circuit.

CCS Common Channel Signaling. A signaling technique in which signaling information, relating to a multiplicity of circuits, and other information, such as that used for network management, is conveyed over a single channel by addressed messages. Class 4 Switch Class 4 is fractional bandwidth, connection-oriented service. Virtual connections are established with bandwidth reservations for a predictable quality of service (QoS). A Class 4 connection is bi-directional with one virtual circuit operational in each direction and supports a different set of QoS parameters for each virtual circuit. These QoS parameters include guaranteed bandwidth and latency. A quality of service facilitator function is provided within the switch to manage and maintain the negotiated QoS on each virtual circuit. When a Class 4 connection is active, the switch paces frames from the source node to the destination node. Pacing is the mechanism used by the switch to regulate available bandwidth per virtual circuit. This level of control permits congestion management for a switch and guarantees access to the destination node. The Switch multiplexes frames belonging to different virtual circuits between the same or different node pairs. Class 4 service provides ‘in-order’ delivery of frames. Class 4 flow control is end-to-end and provides guaranteed delivery. Class 4 is ideal for time-critical applications.

CLASS 5 SWITCH A class 5 switch is the workhorse of today's telephone network. One of these switches, which are analogous to a large mainframe computer, sits in every Central Office of a telephone network and there are thousands of those in the world. Every ordinary voice telephone call goes through a Class 5 switch, which handles the voice signal according to pre-defined parameters. The switches that long-distance companies put in each metro area to connect to the local phone networks were known as Class 4 switches. The Class 5 switch is a circuit switch, switching voice calls on a per-circuit basis, but doing so less efficiently in use of bandwidth than a packet switch, which combines all incoming packets into the available bandwidth to “stuff” transport pipes as fall as possible. Packet switches will one day replace Class 5 voice switches, but not soon.

DACS Digital Access and Cross-Connect System. A computerized or manual facility which allows DS-1/T1 lines to be remapped electronically at the DS-0 (64 kbps) level. Also called DCS or DXS.

DS-1 Domestic Trunk Interface. A DS level and framing specification for synchronous digital streams, over circuits in the North American digital transmission hierarchy, at the T1 transmission rate of 1544000 bits per second.

E1 Wide-area digital transmission scheme used predominantly in Europe that carries data at a rate of 2.048 Mbps. E1 lines can be leased for private use from common carriers.

ECHO CANCELLATION A process which removes unwanted echoes from the signal on a telephone line. Echoes are usually caused by impedance mismatches on a telephone line.

IP Internet Protocol. A protocol for service transfer in which data is sent in variable length packets, containing a header with addressing, type-of-service specification, fragmentation and reassembly parameters and security information. IP is the protocol used by the Internet and most computers for data communications.

ISDN Integrated Services Digital Network. Communication protocol, offered by telephone companies, that permits telephone networks to carry data, voice, and other source traffic.

LAN Local-Area Network. High-speed, low-error data network covering a relatively small geographic area (up to a few thousand meters). LANs connect workstations, peripherals, terminals, and other devices in a single building or other geographically limited area.

LT Line Termination. The network-side interface of the PON. The LT is connected to the backbone lines for service transport of voice, IP data, ATM data and optionally other data.

MAN Metropolitan Area Network: A network designed to carry data over an area larger than a campus such as an entire city and its outlying area.

MPPP Multi-link Point-to-Point Protocol. This is a standard communications protocol used over ISDN to bond separate data-carrying B (smaller) channels together to transfer data effectively through a larger “pipe.” Just as they can under point-to-point protocol (PPP), dissimilar devices can communicate over MPPP connections to access the Internet. MPPP also allows both channels to be used for either voice or data transmissions and supports dynamic bandwidth allocation. This means that one of the two channels can be automatically dropped and reallocated for a phone call when calls come in. Once a call has been completed, the channel can be reconnected to continue data transfer over MPPP.

NT Network Termination. The user-side interface of the PON. The NT is connected to the user's internal infrastructure for service transmission, such as a PBX for voice and a LAN for data.

PBX Private Branch Exchange. Digital or analog telephone switchboard located on the subscriber premises and used to connect private and public telephone networks.

PCM Pulse Code Modulation. PCM is a digital scheme for transmitting analog data. The signals in PCM are binary; that is, there are only two possible states, represented by logic 1 (high) and logic 0 (low). This is true no matter how complex the analog waveform happens to be. Using PCM, it is possible to digitize all forms of analog data, including full-motion video, voices, music, telemetry, and virtual reality (VR).

PON Passive Optical Network. A point-to-multipoint network in which a single LT broadcasts downstream data to multiple NT's, and each NT communicates with the LT in the upstream direction using TDMA methods.

PSTN Public Switched Telephone Network. The collection of interconnected systems operated by the various telephone companies and administrations (telcos and PTT's) around the world.

PRI Prim Rate Interface. ISDN interface to primary rate access. Primary rate access consists of a single 64-Kbps D channel plus 23 (T1) or 30 (E1) B channels for voice or data.

T1 Digital WAN carrier facility. T1 transmits DS-1-formatted data at 1.544 Mbps through the telephone-switching network.

TDMA Time Division Multiple Access. An upstream transmission technique common in point-to-multipoint networks, coordinated in time-slots assigned by the LT, where each slot contains the transmission of a single NT.

VoIP Voice over IP. The ability to carry normal telephony-style voice over an IP-based Internet with POTS-like (plain old telephone service) functionality, reliability, and voice quality. Voice over IP enables a router to carry voice traffic (for example, telephone calls and faxes) over an IP network. In Voice over IP, the digital signal processor (DSP) segments the voice signal into frames, which are then coupled in groups of two and stored in voice packets.

WAN Wide-Area Network. Data communications network that serves users across a broad geographic area and often uses transmission devices provided by common carriers.

WLL Wireless Local Loop.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1 is a is a schematic illustration of prior art separate data and voice networks;

FIG. 2 is a point-to-multipoint schematic view of a converged data network voice network; and

FIG. 3 is a point-to-multipoint schematic illustration of the service connection for a converged network.

### DETAILED DESCRIPTION OF PREFERRED EMBODIMENTS

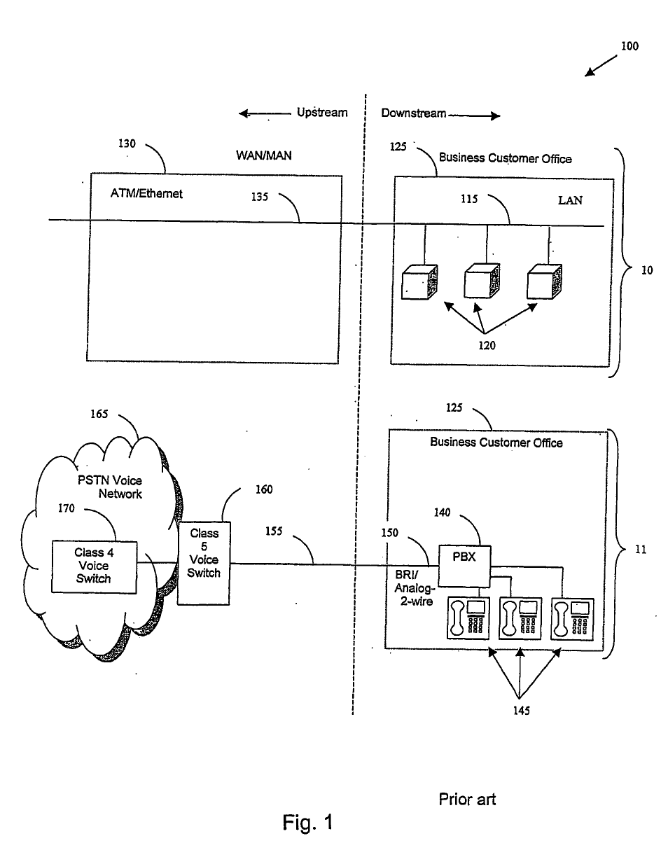

Reference is now made to prior art FIG. 1, which is a schematic illustration of prior art separate networks 100, showing a data network 105 and a voice network 110. Data network 105 includes a local area network (LAN) 115 for connecting hardware elements 120, such as personal computers in a business customer office 125. LAN 115 is connected to a larger wide area network or metro area network (WAN/MAN) 130, using connectivity via Ethernet or asynchronous transfer mode (ATM) 135.

Voice network 110 also connects business customer office 125, but generally connects telephones 140 using a PBX 145. PBX connects upstream via a basic rate interface (BRI) or analog 2-wire 150 or wider connections are made using a primary rate interface (PRI) or channel associated signaling (CAS) 155. A class 5 switch 160 is generally used to connect to the public switched telephone network (PSTN) 165, and internal connections for PSTN 165 are made using a class 4 switch 170.

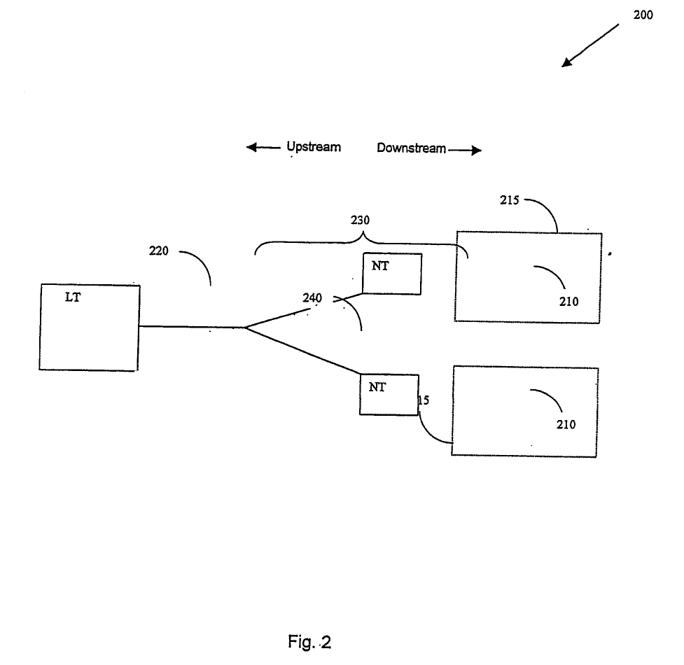

FIG. 2 is a point-to-multipoint network schematic view of a converged network 200 wherein data network 105 and voice network 110 of FIG. 1 are combined. Each network termination (NT) 210 is generally located at a different customer's premises 215. The line termination (Lf) 220 aggregates all the upstream traffic, which is in native form from many NT's 210. The convergence network line 230 is a fiber optic, passive optical network (PON). The splitting device 240 is a passive, i.e. mirror-like, device that splits the carrier frequency light beams.

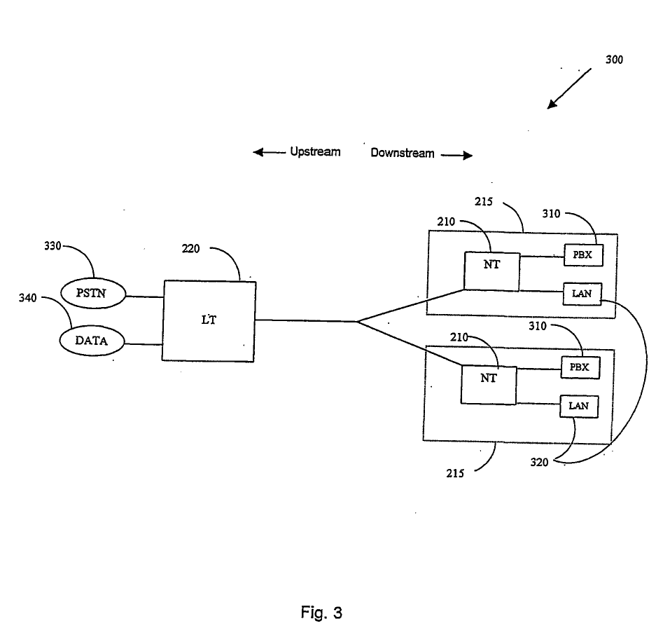

FIG. 3 is a point-to-multipoint schematic illustration of the service connection 300 for a converged network. Each NT 210 is located at customer premises 215 and serves its PBX 310 and LAN 320. LT 220 aggregates all this traffic and connects the voice to PSTN 330, and the data to the various data networks 340, Internet protocol (IP) network, ATM network or others.

The solution has several characteristics:

voice is transferred in a native format—i.e., using pulse coded modulation PCM) samples;

voice signaling is relayed to PSTN 330; and

bandwidth for voice and data calls is allocated dynamically.

For voice transmission, PBX 310 has several interfaces upstream towards PSTN 330. It may be a proprietary digital interface like T1/E1 or integrated services digital network ISDN, or a 2-wire analog interface. T1 lines carry 24 calls in U.S.-based systems and E1 lines carry 30 calls in Europe-based systems. In the first step, from PBX 310 to NT 215 all of them are transported as 64-kbits/sec PCM samples. In the next step only active calls are transferred from NT 215 towards LT 220. There is no need to do compression or echo cancellation, because the voice is transferred natively. At LT 220, all the voice traffic, which is carried upstream, is directed toward PSTN 330. Only the pre-configured slots are transferred. This is also known as digital cross connect (DCC).

NT 215 terminates voice signaling. In the case of primary rate interface (PRI), voice signaling is relayed over the system towards PSTN 330. In the case of a basic rate interface (BRI), the signaling is multiplexed into a PRI signaling channel. When signaling is CAS, it is terminated at NT 215 and inserted again at LT 220. In the case of an analog interface, signaling is multiplexed and inserted at LT 220.

The system can detect whenever a voice call is active. This is done at each NT 215, for outgoing calls, and at LT 220 for incoming calls. The information on voice calls setup is always sent to LT 220. With this information LT 220 can grant a new bandwidth for each voice call. Data traffic is classified and arranged in queues at each NT 215. LT 220 gets details on the queue and provides allocations for each NT 215 according to several criteria. Several dynamic bandwidth allocation (DBA) algorithms for data can be implemented.

In a typical small-to-medium business only a portion of the 24 T1 calls or the 30 E1 calls available for a network termination are active at any given time during business hours. Operators currently use DACS to multiplex partial E1 or T1 bandwidth to save some of the E1 or T1 lines. For example, by use of existing DACS technology, two user-side T1 lines with 12 channels each, can be cross-connected at a DACS to one network-side 24 channel T1 line. Such prior art use of DACS is now done for a separate voice network. The present invention implements the cross-connection of the native voice in parallel to the optical network converged connection of the data. The voice connections are made using the physical optical network connections, only because they already are in place. Other forms of connections can also be used.

1. A method for converging data signals over a data network having a data network protocol and voice information comprising
pulse code modulated voice samples; and
signaling protocols,
over a voice network having a voice network protocol using a point network to multipoint network system architecture, wherein said multipoint network has at least two network terminations (NT's), comprising;
receiving a first telephone call, originated by a PBX, at one of said at least two network terminations;
receiving a second telephone call, originated by a PBX, at another of said at least two network terminations;
transferring said voice samples from said NT of said first call to the line termination (LT) of said multipoint network, and from said NT of said second call to said LT of said multipoint network, wherein said first call and said second call are still active calls;
multiplexing said first call in said line termination to connect to the public switched telephone network (PSTN) via a transmission channel; and
multiplexing said second call in said line termination to connect to said PSTN via a transmission channel,
such that said multiplexing results a saving of the number of transmission channels required.

2. The method of claim 1, wherein said multiplexing is via the technology of a digital access and cross-connect system (DACS).

3. The method of claim 1, wherein said data and voice signals are already transmitted, and said multiplexing is parallel to said converged data signals.

4. The method of claim 1, wherein said data and voice signals are already transmitted via a passive optical network (PON).

5. The method of claim 1, wherein more than two calls are multiplexed.

6. The method of claim 5, wherein only active calls are transferred, thereby resulting in savings of bandwidth.

7. The method of claim 6, further comprising implementing dynamic bandwidth allocation (DBA) algorithms for said data signals.
